(19) United States
(12) Patent Application Publication
(10) Pub. No.: US 2012/0036366 A1
(43) Pub. Date: Feb. 9, 2012

(54) SECURE AND VERIFIABLE DATA HANDLING

(75) Inventors: Robert A. May, Redmond, WA (US); Ali Emami, Seattle, WA (US); Gaurav D. Kalmady, Kirkland, WA (US); Umesh Madan, Bellevue, WA (US); Sean Nolan, Bellevue, WA (US); Joyce C. Cunningham, Redmond, WA (US)

(73) Assignee: MICROSOFT CORPORATION, Redmond, WA (US)

(21) Appl. No.: 12/853,179

(22) Filed: Aug. 9, 2010

(51) Int. Cl. H04L 9/00; G06F 15/16; G06F 21/00

(52) U.S. Cl. 713/176; 726/26; 709/217

(57) ABSTRACT

The described implementations relate to secure and verifiable data handling. One implementation can receive a request to upload information, wherein the information includes a referencing element and at least one blob of referenced data. This implementation can also receive a chunk of an individual blob. The chunk can include multiple blocks. Individual blocks can be hashed. Upon receipt of an indication that all chunks have been uploaded, this implementation can create an overall hash of the information from the block hashes rather than from the information.

### BACKGROUND

Traditional secure data handling techniques are ill equipped to handle large amounts of data, such as may be encountered with images, video, etc. In these scenarios, the ability to secure the data depends upon possession of all of the data at a single instance. With large amounts of data, the induced latency of such a requirement makes data handling impractical.

### SUMMARY

The described implementations relate to secure and verifiable data handling. One implementation can receive a request to upload information. The information can include a referencing element and at least one blob of referenced data. This implementation can also receive a chunk of an individual blob. The chunk can include multiple blocks. Individual blocks can be hashed. Upon receipt of an indication that all chunks have been uploaded, this implementation can create an overall hash of the information from the block hashes rather than from the information.

Another implementation includes a communication component configured to receive requests for a portion of a blob associated with a referencing element. The blob can include one or more units. This implementation also includes a unitization component configured to identify individual units in which the portion is stored. This implementation further includes a security component configured to validate the individual units without accessing an entirety of the blob.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 shows an example of a scenario for implementing secure and verifiable data handling concepts in accordance with some implementations of the present concepts.

FIGS. 2-3 collectively illustrate an example of information that can be securely and verifiably handled in accordance with some implementations of the present concepts.

FIGS. 4-5 illustrate examples of flowcharts of secure and verifiable data handling methods in accordance with some implementations of the present concepts.

FIG. 6 is an example of a system upon which secure and verifiable data handling can be implemented in accordance with some implementations of the present concepts.

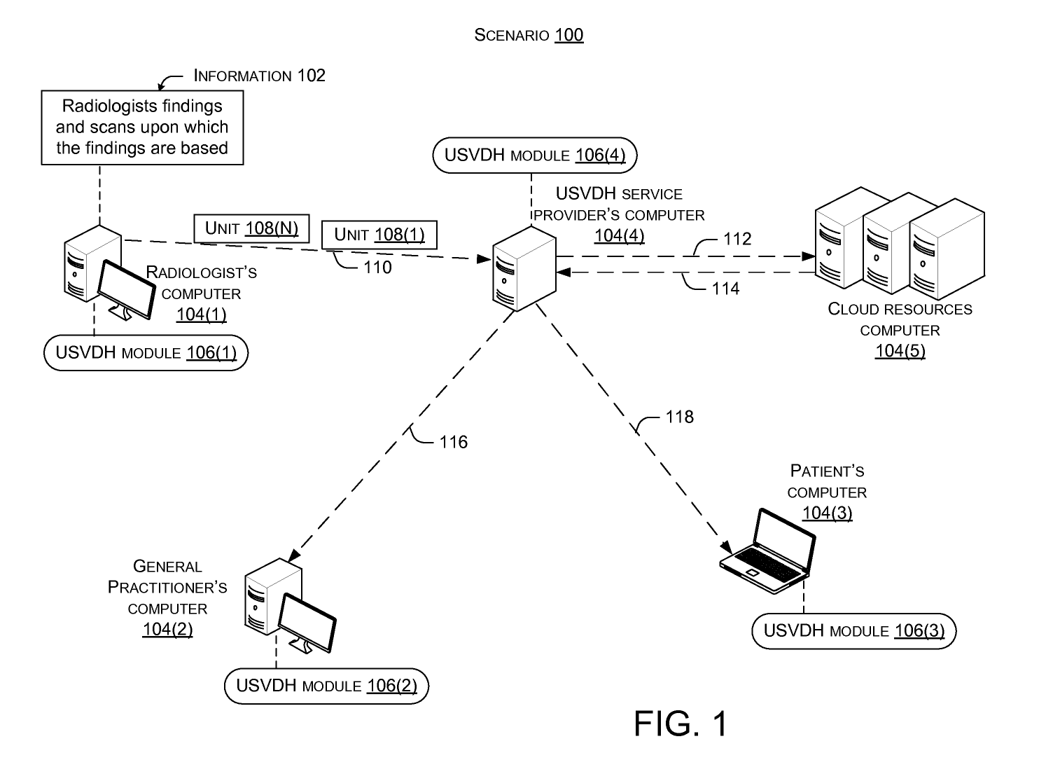

### DETAILED DESCRIPTION

### Overview

This patent application relates to information handling in a secure and verifiable manner that is suitable for handling very large amounts of data. The information can be secured in a manner that allows it to be safely stored by an un-trusted third party. In some implementations, the data can be unitized. Unitized data can be hashed and/or encrypted. For instance, each unit of data can be individually hashed. An overall data hash can be created from the hashes of the units such that an entirety of the data need not be possessed to secure the data. Unitization allows fewer resources to be utilized in handling the data without compromising data security.

Among other configurations, the present concepts can be applied to a scenario where the information is manifest as an element, such as a document that references data that is not contained in the element. (Hereinafter, the element is referred to as the “referencing element”, while the data is referred to as the “referenced data”). The referenced data can be unitized and the security of each unit can be verified. Thus, the present implementations lend themselves to scenarios where the referenced data entails very large amounts of data, such as may be encountered in images, such as medical images or video, among others.

Considered from one perspective, the present concepts can be thought of as offering unitized secure and verifiable data handling (USVDH). The discussion below explains how USVDH can address uploading, storing, and retrieving referenced data that may be manifest in multiple units, such as blobs (or BLOBs). (The term is a common abbreviation in the field for Binary Long Object). Individual referencing elements can range from small to large in size, measured in bytes. The discussion also addresses how a reader of the referenced data can validate its integrity and source using hashes and digital signatures. The discussion further addresses the problems associated with transmitting large data over unreliable networks and uploading data in an out-of-order or parallel fashion for better throughput.

### Example Scenario

The discussion above broadly introduces USVDH concepts. To aid the reader in understanding these concepts, scenario 100 provides a tangible example to which the concepts can be applied. Example scenario 100 involves information in the form of patient medical records. Patient medical records can be quite large and, by law, require high security. This example is provided for purposes of explanation, and the present concepts can be applied to other scenarios outside of medical records, such as legal records, financial records, government classified data, etc.

Scenario 100 includes information 102 in the form of a patient's records that include radiologist's findings and scans upon which the findings are based. For purposes of explanation this example includes five computers 104(1)-104(5). Computer 104(1) is the radiologist's computer, computer 104(2) is the patient's general practitioner's computer, computer 104(3) is the patient's computer, computer 104(4) is a USVDH service provider's computer and computer 104(5) is a third party computer. For purposes of discussion, computers 104(1)-104(3) can be thought of as client computers. Computers 104(1)-104(4) can include USVDH modules 106(1)-106(4), respectively. Assume further that the USVDH service provider's computer 104(4) via its USVDH module 106(4) in cooperation with the client computers can offer a secure and verifiable patient record storage system. Briefly, one feature that can be offered with this system is the ability to guarantee security and integrity of patient information even when the information is stored at an untrusted third party location, such as computer 104(5). For instance, computer 104(5) may be representative of third party cloud computing resources.

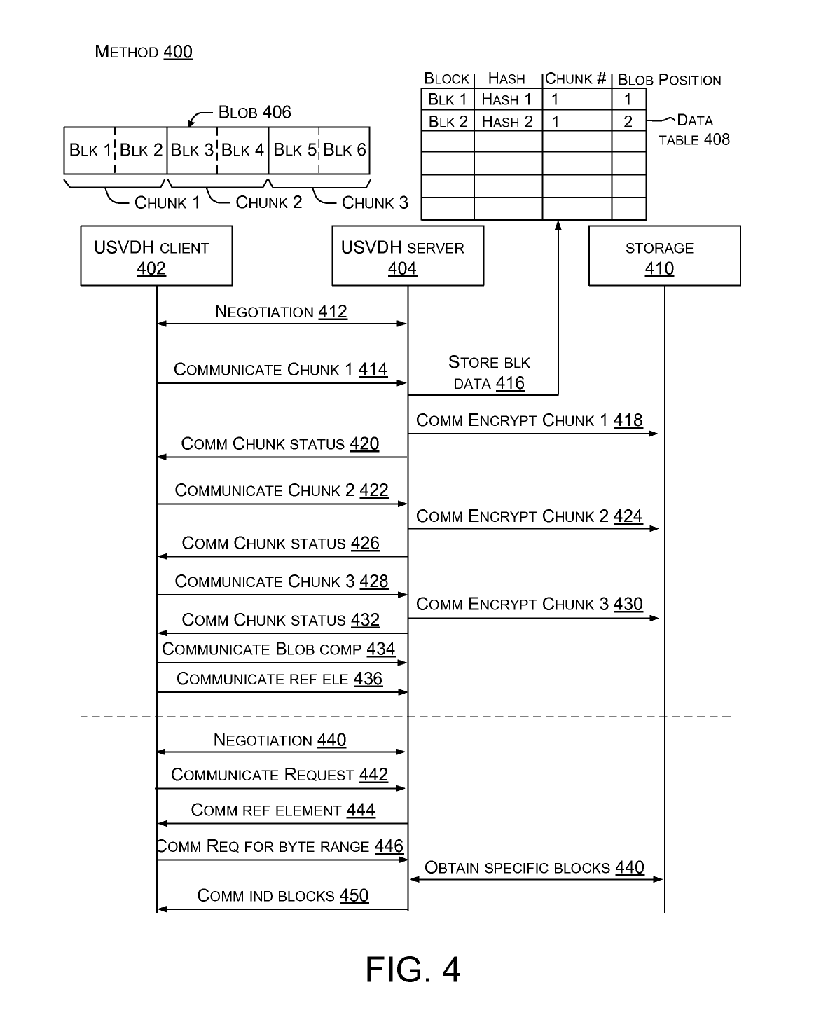

Assume for purposes of explanation that the information 102 was generated when the patient visited the radiologist. The radiologist took images, such as CT scans and/or MRIs. Images tend to include relatively large amounts of data. The radiologist evaluated the images and generated a report of his/her findings that references the images. In this example, the radiologist's report is an example of a referencing element and the images are examples of referenced data. The USVDH module 106(1) on the radiologist's computer 104(1) can facilitate communicating the information to the USVDH service provider's computer 104(4). For instance, the USVDH module 106(1) can negotiate with USVDH module 106(4) regarding conditions for communicating information 102 to the USVDH service provider's computer 104(4). Briefly, such conditions can relate to identifying a unique ID of the patient or patient account and/or communication channels over which the information is communicated and/or parameters for hashing, among others. Examples of these conditions are described in more detail below and also relative to FIG. 4.

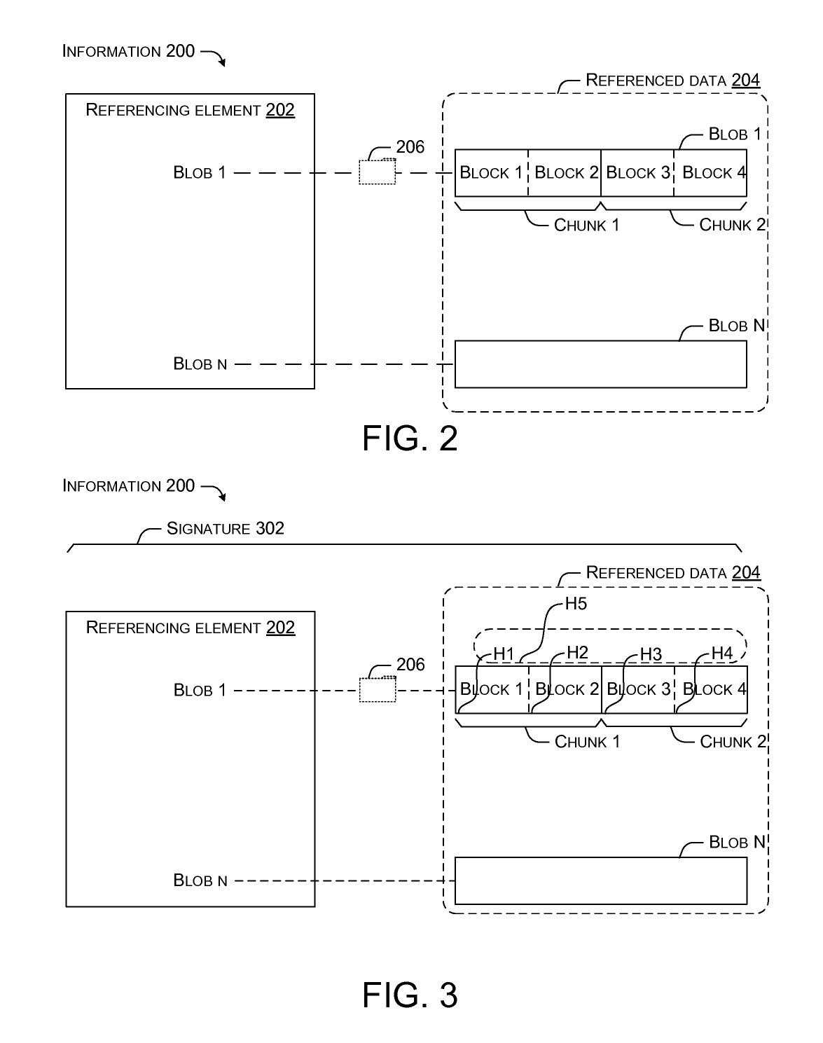

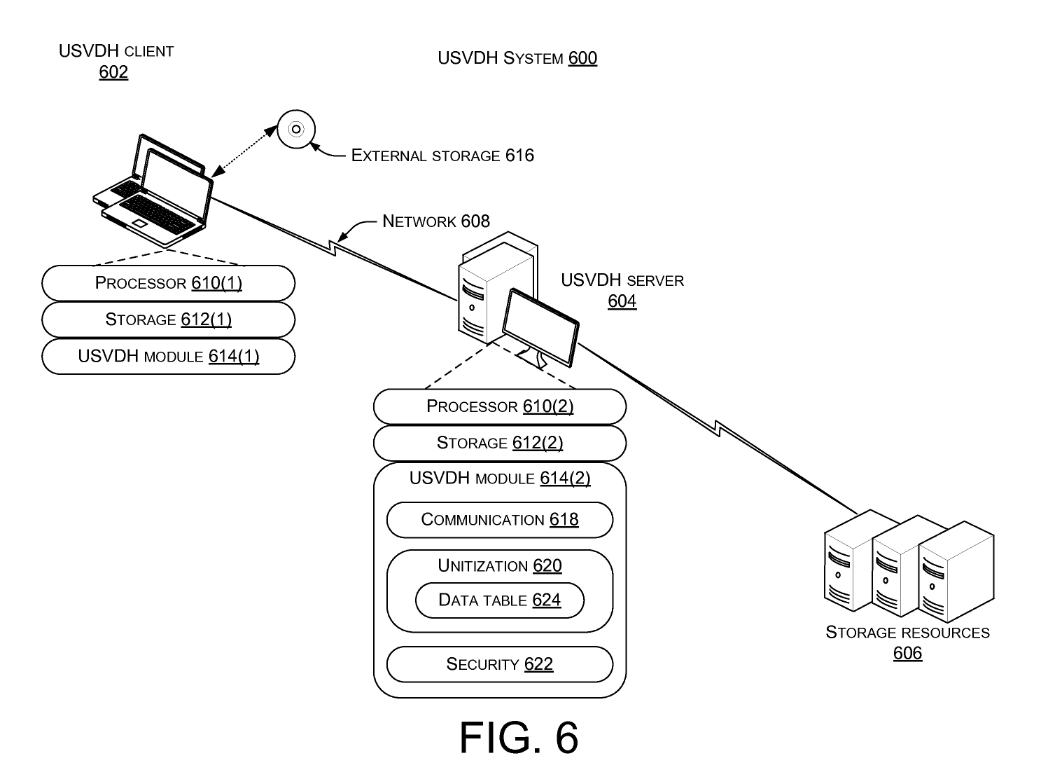

The present implementations can handle situations where information 102 is a relatively small amount of data. These implementations can also handle situation that involve very large amounts of data, such as represented by the described patient images which are often multiple gigabytes each. Toward this end, the USVDH module 106(1) on the radiologist's computer 104(1) can unitize information 102 into one or more units 108(1)-108(N) (“N” is used to indicate that any number of units could be employed). The units can be sent to USVDH service provider's computer 104(4) as indicated by arrow 110. Examples of units are described in more detail below relative to FIGS. 2-3. In some implementations, unitizing the data can allow the data to be sent over multiple channels, from multiple different computers at the radiologist's office, and/or without regard to ordering of the units. This aspect will be discussed in more detail below relative to FIGS. 4 and 6. Further, the present implementations can handle the individual units and the overall information in a secure and verifiable manner. For instance, the radiologist's office can send units of data to the USVDH service provider's computer 104(4).

The USVDH service provider's computer 104(4) can hash individual units and create a hash of the patient information utilizing the individual hashes. The USVDH service provider's computer can also encrypt individual units. By encrypting individual units, the USVDH service provider's computer does not need to possess all of the information at one time and can instead send secure units to third party computer 104(5) as indicated by arrow 112. Thus, the USVDH service provider's computer can handle individual units as they are received rather than having to acquire all of the information 102 before processing. In such a configuration, each unit can be hashed and encrypted so that the USVDH service provider's computer does not need to rely on the security of third party computer 104(5).

Once the USVDH service provider's computer 104(4) receives all of the patient information, it can create an overall hash from the individual unit hashes. Thus, again this configuration does not require the USVDH service provider's computer to be in possession of all of the patient information to create the overall hash. Instead, the overall hash can be created from the hashes of the individual units. The USVDH concepts also allow the radiologist an opportunity to digitally sign the patient information that was uploaded to the USVDH service provider's computer.

Assume for purposes of explanation that, at a subsequent time, the patient's general practitioner wants to access some of the patient information. The general practitioner can access some or all of the patient information via the USVDH service provider's computer 104(4) by supplying a unique ID for the information. Further, assume that the general practitioner only wants to see the radiologist's findings and one of the images.

The USVDH service provider's computer's USVDH module 106(4) can retrieve individual units 108(1)-108(N) that include the desired portions of the information from the third party cloud resources computer 104(5) as indicated by arrow 114. The USVDH service provider's computer 104(4) can then send the relevant units of the patient information to the general practitioner's computer 104(2) as indicated by arrow 116. This implementation can further allow the general practitioner to verify the integrity of the supplied patient information and the digital signature of the radiologist. Similarly, the patient can access any part, or all, of the patient information utilizing patient computer 104(3) as indicated by arrow 118. In each case, the USVDH service provider's computer 104(4) can obtain individual units of the patient information, decrypt the units and forward the units to the patient or general practitioner without being in possession of all of the patient information. Note also, that the patient's information need not be static. For instance, either the general practitioner or the patient can alter the patient information by adding/removing data and can also be given the option of re-signing after the changes. Note further still that while for sake of brevity each of computers 104(1)-104(5) are discussed in the singular sense, any of these computers could be manifest as multiple machines or computers. For instance, USVDH service provider's computer 104(4) could be distributed, such as in a cloud computing context in a similar fashion to cloud resources computer 104(5). This aspect is discussed in more detail below relative to FIG. 6.

In summary, the USVDH concepts can offer a reliable protocol for uploading data to a server and storing the data in a persistent data store, such as a cloud storage system, a database, or a file system. As the data is uploaded to the server, metadata can be computed that is used to generate a small unique digest (i.e., hash) of the data which can be used to guarantee the integrity of the data. The data can be grouped into collections or units which can be referenced by referencing elements or referencing elements within an electronic health record or other logical container of data, and the referencing elements and the referenced collection of data can be read and the integrity of this data verified by a reader of the referencing elements.

The USVDH concepts can further allow selectively creating collections of data items (e.g., referenced data) that are uploaded to a server and keeping a reference to this collection through referencing elements which can be stored in an electronic health record. The USVDH concepts can additionally offer the ability for the data item collection to be modified by adding or removing items. The USVDH concepts also offer the ability to specify the sections of referenced data to retrieve, since the referenced data may be large and often only a section of the referenced data is needed.

The USVDH concepts can offer an ability to generate a digest of the referenced data as it is uploaded to the server. The digests can be used by readers of the referenced data to ensure that the referenced data has not been tampered with or modified in any way by a party with access to the referenced data, by the storage system or any intermediate storage system, or by unintended changes in the referenced data such as network, hardware, or software errors. Stated another way, the present implementation can offer the ability to generate a digest of the referencing element and the referenced data without needing the referencing element and the referenced data in their entirety at any given time.

The above features can allow the referenced data, such as blob data to be stored in a system that is external from the one which the client interfaces. Briefly, the ability to safely store the referenced data in such a manner can be supported by encrypting the referenced data on a unit by unit basis. For example, the clients can be thought of as computers 104(1)-104(3) which interact with USVDH service provider's computer 104(4), but do not interact with cloud resources computer 104(5). In a particular example the client can interface with USVDH service provider's computer 104(4) manifested as HealthVault-brand health records system offered by Microsoft Corp. HealthVault can then interface with an external store, (e.g., cloud resources computer 104(5)) such as Azure™, SQL storage™, a storage appliance (i.e. EMC™, IBM™, Dell™, etc.). These concepts are described in more detail below by way of example.

### Information Example

FIGS. 2-3 collectively show an example of information 200 that can be managed utilizing the present unified secure verifiable data handling concepts. The information could be patient records, financial records, etc. In this case, information 200 is manifest as a referencing element 202 that is associated with referenced data 204 that is external to the referencing element. In this example, the referenced data is in the form of blob 1 and blob N. It is worth noting that this configuration allows different blobs to be stored in different storage systems. For instance, blob 1 could be stored in Azure, while blob N is stored in SQL storage. Also, the referenced data 204 can be organized via one or more optional intervening organizational structures, such as a folder 206 (shown in ghost), but this aspect is not discussed further herein.

As mentioned above, an individual blob can be almost any size from small to very large. Very large blobs, such as video or medical images, may create latency issues when managed utilizing traditional techniques. The present implementations can allow individual blobs to be unitized into more readily manageable portions. In this example, blob 1 is unitized into two chunks designated as chunk 1 and chunk 2. Further, individual chunks can be unitized into blocks. For instance, chunk 1 is unitized into block 1 and block 2 and chunk 2 is unitized into block 3 and block 4.

The blocks and/or chunks are more readily handled in a secure and verifiable manner than their respective blobs. Toward this end, a small unique digest, such as a hash of an individual unit, can be generated to (attempt to) guarantee the integrity of the data or content of the individual unit. In this example, as indicated in FIG. 2, a hash can be created for each block. For instance, hash H1 is generated for block 1, hash H2 for block 2, hash H3 for block 3, and hash H4 for block 4. A hash can be created for the blob from its respective unit hashes without possessing all of the blob data at one time. For instance, hash H5 can be generated from hashes 1-4 rather than from the blob data itself. Further still, an entity, such as a user, can sign referenced data 204 and/or the referencing element 202 and a part or the entirety of the referenced data 204. Some implementations allow a single signature over the referencing element and the referenced data. In one such example signature 302 indicates the source and/or integrity of referencing element 202 and referenced data 204. The above example is but one implementation of the present unitized secure verifiable data handling concepts. Other implementations should become apparent from the description below.

As used herein, the term blob can be used to refer to the referencing elements and/or referenced data described above that will be uploaded to the server. This refers to data that is treated as a series of bytes by a system. The bytes may have some logical structure such as a JPEG image or an MPEG movie. However, a system can interpret the data to discover this structure, for example by reading the first n bytes and auto-detecting its format against a set of known patterns. Alternatively, the system may know the structure of the bytes through means external to the data itself, for instance through a parameter or metadata indicating the format of the blob. When a system treats data as a blob, the data may be referred to as ‘unstructured,’ meaning the system treats the data as a simple series of bytes without any understanding of the structure of those bytes. Thus, any data that can be interpreted as a series of bytes can be considered a blob and thus is valid data that can be used with the present implementations.

A blob is a series of bytes and can be thought of as a series of chunks, where each chunk is a series of bytes. For instance a blob with 100 bytes will have 10 chunks if the chunk size is 10 bytes. Thus, a blob can be thought of as a series of bytes, or as a series of chunks. The concept of chunk allows discussion of a blob in terms of its constituent chunks. The concept of a chunk exists once a numerical chunk size is defined for a particular context.

For a particular context, a number of bytes can be defined as a chunk. The term full chunk may be used throughout to refer to a chunk whose length is exactly equal to chunk size. In contrast, a partial chunk is a chunk of data that does not have a length exactly equal to the chunk size defined for the particular context. Also, the length of the partial chunk should be between 1 and (chunk size−1). The length of a partial chunk cannot be 0 because this implies the partial chunk does not exist, also the partial chunk cannot have length equal to chunk size since this implies that it is a full chunk. If the chunk size is defined as 1 in the context, then it is not possible to have a partial chunk.

Just as a blob can be partitioned into a series of chunks, a chunk can be partitioned into a series of blocks once a numerical block size is defined for a particular context. In some implementations, the chunk size is defined to be a multiple of the block size (e.g., the blocks are integer factors of the chunk). This can facilitate restartability in case of a network error during blob upload. Other implementations that do not utilize a chunk size that is a multiple of block size can also offer restartability, however, the process may be significantly more resource intensive. These features are described in more detail below relative to FIG. 4.

A blob hash algorithm can be used to produce a cryptographic hash of a blob. Two examples of blob hash algorithms are described in this document. The first is the ‘Block hash algorithm’ and the second is the ‘Chained Hash algorithm’ (described below).

A blob hash is a cryptographic hash of the blob. This hash is accompanied by a hash algorithm and the parameters for producing the hash from the data. A hash block size can be thought of as the block size parameter to use with the blob hash algorithm.

Block Hash Algorithm Example

Consider a blob for which the blob hash is to be produced using the block hash method. The inputs to the algorithm are the base hash algorithm and block size. The base hash algorithm is any cryptographic hash function that takes as input a series of bytes and produces a digest or hash (for instance SHA-256, SHA-1, etc.). The blob is partitioned into n blocks based on the input block size. Each block is numbered in sequential byte order of the blob starting with block number 0.

A hash can be calculated for each block using the base hash algorithm. The process can be repeated for each block. The block hashes can be organized in any fashion to be hashed to produce a blob hash. In one such case, the block hashes are organized in sequential order and the base hash algorithm is utilized to create the blob hash.

As a specific example assume h0, h1, h2 represent the block hashes for a blob with three blocks b0, b1, b2. Thus, h0=hash (b0), h1=hash (b1), h2=hash (b2). Then the blob hash h is computed as h=hash (h0|h1|h2), where the | is the function to append the block hash bytes.

Chained Hash Algorithm Example

Consider a blob for which the blob hash is to be produced using the chained hash method. The inputs to the algorithm are the base hash algorithm and the block size. The base hash algorithm is any cryptographic hash function that takes as input a series of bytes and produces a digest or hash (for instance SHA-256, SHA-1, etc.). The blob is partitioned into n blocks based on the input block size. Each block is numbered in sequential byte order of the blob starting with block number 0.

A hash h0 is calculated using an array of bytes with all bytes having the value ‘0’ and length equal to a hash result, and the first block of the blob. h0 is used as input for the next block of data. Specifically, h0 is appended to the next block and the hash of this joinder is calculated to produce h1. h1 is appended to the subsequent block and the hash calculated, producing h2. The process can continue until the hash of the last block is calculated which represents the final blob hash.

As a specific example, assume a blob with blocks b0, b1, b2. First, h0 is computed as hash (0|b0), where 0 is an array of bytes with the values being zero with length equal to the size of a hash result. Next, compute h1=hash (h0|b1). Finally, h2=hash (h1|b2). The blob hash here is h2.

### First Method Example

FIG. 4 shows a USVDH method example 400. This method relates to accomplishing a ‘put’ of information and a ‘get’ of the information. The ‘put’ can be thought of as an upload protocol description that is consistent with some implementations. The ‘get’ can be thought of as a download protocol description for retrieving information that is consistent with some implementations. For purposes of explanation, consider this method example as an interaction between a USVDH client 402 that wishes to upload information in the form of a set of blobs to a USVDH server 404, and associate those blobs with a referencing element that may describe the blobs. The USVDH client further wishes to persist the referencing element and blobs such that both can be retrieved through a different interaction, such as the ‘get’. For sake of brevity, only a single blob 406 of the set of blobs is illustrated. The method can also be applied to additional blobs of the set. The server can access a data table 408 and storage 410. It is also noted that the method is described relative to the USVDH client 402 and the USVDH server 404 to provide a context to the reader. The method is not limited to execution by these components and/or modules and can be implemented in other context, by other components, modules and/or systems.

Initially, at 412, a negotiation can occur between USVDH client 402 and the USVDH server 404. In one case, the negotiation can involve the USVDH client 402 making a request to the USVDH server 404 indicating the client's desire to upload blob 406. In some implementations, there may be some mechanisms in place to identify USVDH clients making this request, or to restrict the USVDH clients that can successfully indicate their desire to upload a blob. In the request, the USVDH client can specify the parameter values it supports or wants to use for uploading the blob. Alternatively or additionally, the USVDH service provider might specify some of the parameters. Examples of these parameters can include a location identifier parameter, a token, a maximum blob size, a chunk size, a blob hash algorithm, and a hash block size, among others.

The location identifier parameter can identify where the data should be sent (i.e., a URL for instance). The token can uniquely identify the blob being uploaded. The maximum blob size can be thought of as the maximum size the USVDH server 404 will accept from the USVDH client 402 for the whole blob that is being uploaded. The chunk size, blob hash algorithm, and hash block size are discussed above relative to FIGS. 2-3.

The blob hash algorithm can be used for calculating the blob hash. The hash block size can be used as input to the blob hash algorithm to calculate the blob hash. In some cases, the USVDH server 404 may provide a range for an individual parameter and let the USVDH client 402 pick a parameter value from the range. The USVDH client also can have the option of letting the USVDH server decide the parameter values it will use for the parameters. The interface is flexible in supporting any number of new parameters going forward.

The above mentioned negotiation process between the USVDH client 402 and USVDH server 404 to agree upon the parameters can be advantageous when compared to other solutions. For example the ability to have adjustable parameters potentially offers flexibility over fixed configurations. For example, the USVDH server can respond with a set of parameters based on some conditions or events. For instance, the location identifier can be different for each blob request, or for each USVDH client, based on some knowledge of server load or location of the client as examples. This means each blob can have a different set of blob upload parameters. Another potential advantage of this is in terms of software servicing. Since USVDH clients can be coded to dynamically interpret the protocol parameters, the method can be much more flexible and can prevent the need to update client code in many cases; for instance, if a chunk size or block size needs to change.

Once the negotiation is complete, the USVDH client 402 can communicate a chunk of data to the USVDH server 404. In the illustrated case, blob 406 is divided into chunk 1, chunk 2 and chunk 3. In one case, the USVDH client can construct a request that contains a chunk of data from the blob and sends this chunk to the USVDH server. In the present example, the USVDH client communicates chunk 1 at 414. The USVDH client does not send the next chunk (i.e., chunk 2) until a receipt is received from the USVDH server that first chunk has been received and processed. This can be termed a serial approach. Further, in this example, the chunks are communicated in order, (i.e., first chunk, second chunk, then third chunk, but such need not be the case). Other implementations can employ a parallel approach where multiple chunks are communicated simultaneously. This aspect will be discussed in more detail below.

In some implementations, the request from the USVDH client 402 includes some information that identifies what data within the blob 406 is being uploaded in the request. For example, this can be a byte range within the blob specified by a starting byte offset and an ending byte offset within the blob data that is being transmitted to the USVDH server 404 in the request.

In some particular implementations, the USVDH client 402 transmits full chunks of the blob data to the USVDH server 404 in a single request, except for the last chunk of the blob which may be a partial chunk. A full chunk has length equal to ‘chunk size’ as defined by the negotiated upload parameters which are described above relative to FIGS. 2-3.

In these particular implementations, the USVDH client 402 can transmit a single chunk or multiple chunks of BLOB data in a single request, as long as they are all full chunks with the exception of the last chunk of the blob.

This requirement, employed by particular implementations, to transmit only full chunks of blob data to the USVDH server 404 applies only to the blob data being transmitted and does not apply to any preamble data, header data, message envelope data, and/or protocol data, among others, that is transmitted by the USVDH client 402 to the USVDH server in making the request to the server. Other USVDH implementations may be configured differently from the above described example and thus are not bound to any ‘requirements.’

The USVDH server 404 can receive the first chunk of data as indicated at 414. The USVDH server can calculate intermediate hashes as output by the intermediate steps in the blob hash algorithm (block hash or chained hash) for each block within the transmitted chunks. Thus, the algorithm's output itself can be the blob hash.

At 416, the method can store chunk and/or block data in the data table 408. For instance, the block data can relate to the block number, the hash of the block, and the overall position of the block in the blob, among others. While not expressly shown due to space constraints on the drawing, this step can be repeated for the other chunks received at 422 and 428. For reasons that should become apparent below, the block hashes can be thought of as ‘intermediate hashes.’

The chunks transmitted to the USVDH server 404 are partitioned into blocks based on the block size from the blob upload parameters. Since an integer number of chunks were transmitted to the USVDH server and the chunk size is a multiple of the block size, the USVDH server can be guaranteed to have received an integer number of blocks.

In the case where the block hash algorithm is used, the USVDH server 404 can compute a hash for each block received. These intermediate hashes are stored in the data table 408 so they can be read at a later point in time.

In the case where the chain hash algorithm is used, the current intermediate hash is appended to the first block of the data received and the chain hash algorithm applied. If it is the first block of the blob then the 0 array as described in the algorithm is used and the chain hash algorithm started. Once all blocks in the data received are processed and the resulting hash is determined (i.e., the blob hash), this resultant blob hash is stored, such as in data table 408, so as to be able to retrieve the resultant blob hash at a later time.

At 418, chunk 1 can be encrypted and the encrypted chunk can be communicated to storage 410. Any type of encryption technique can be employed. Since the chunk is encrypted, the storage need not be trusted. Accordingly, storage 410 may be associated with the USVDH server 404 or may be associated with a third party, such as a cloud storage system.

Stated another way, the USVDH server 404 can store the blob data to a store such as a cloud storage system, a database, or a file system as examples. The USVDH server can also store some metadata, such as in data table 408, identifying what section of the blob was received, based on the info specified by the USVDH client. The metadata can be read at a later time. In cases where the metadata and the data itself are stored in different storage systems that cannot be transacted, then the possibility can arise where the data is stored but an error occurs storing the metadata. Often times the data can be large and can be expensive to store. Thus, in this case the system can ensure the data that was stored is rolled back or cleaned up by a different interaction.

Once the metadata is successfully stored, the USVDH server 404 can respond to the USVDH client 402 indicating that individual chunk(s) were successfully written. This is indicated as communicate chunk status 420. For its part, the USVDH client received the status or acknowledgement from the USVDH server that the chunks were successfully stored by the server, or the USVDH client may receive an error code from the USVDH server, or may time out waiting for a response.

In the illustrated implementation, the USVDH client 402 waits to gets a response acknowledgement of success from the USVDH server 404, then the client proceeds to send the next chunks of the blob data. In this case, chunk 2 is communicated at 422. However the USVDH client need not wait for a response from the USVDH server 404 server to begin a chunk transmission for a different range of the blob. Viewed from one perspective this can be described as the ability for USVDH clients to upload data in parallel. The USVDH client has this option if the blob hash algorithm is the block hash algorithm, but does not have this option if the algorithm is the chained hash algorithm. In the case of the chained hash algorithm, the chunks are sent in ascending sequential order and parallelization is not possible.

Additionally, the USVDH client 402 has the option to send chunks out-of-order. This means that the chunks do not have to be sent in sequential order if the blob hash algorithm is the block hash algorithm. This option does not exist if the chained hash method is used.

The USVDH client 402 cannot be sure that the data of a given chunk was stored until the response acknowledgement for a given chunk request has returned a successful acknowledgement. If the USVDH client 402 received an error from the USVDH server 404 while waiting for the response, then the USVDH client can determine if the error is caused by an action that can be corrected by the client or if the error was a USVDH server specific error. This determination can be made by knowledge of error codes and other information utilized by the USVDH server. If possible the USVDH client can take action to correct the issue and continue to process or uploading blob data. In the case of a USVDH server or network error, the USVDH client can retry the request by sending it to the server again. Likewise, if the USVDH client times out waiting for a response from the USVDH server, then the USVDH client can attempt the request again.

For ease of explanation, assume that the chunks are received and handled successfully by the USVDH server 404. Recall that chunk 2 was communicated at 422. The USVDH server encrypted chunk 2 and communicated chunk 2 to storage at 424. The chunk 2 status is communicated to the USVDH client at 426. Also, note that, while not shown, data relating to chunk 2 is added to data table 408. Similarly, chunk 3 is communicated at 428. Chunk 3 is encrypted and then communicated to storage at 430. The status of chunk 3 is communicated back to the USVDH client at 432.

At some point the USVDH client 402 can mark the blob as being complete and no more data can be added to the BLOB. For instance when the last chunk is uploaded to the USVDH server 404 at 428, the USVDH client can include in this request some information indicating it is done uploading data for this blob. Alternatively, the USVDH client can send a request with no blob data but that indicates the blob is complete. For instance, a blob complete communication is indicated at 434.

When the USVDH server 404 receives this blob complete communication 434, the USVDH server can first process any chunks in the request as described above. Subsequently, the USVDH server can read the intermediate hashes from data table 408, and can compute the blob hash as defined by the blob hash algorithm. For block hashing, the USVDH server can sequentially append the block hashes together and compute an overall blob hash from the block hashes. For chain hashing, the current intermediate hash is the blob hash. The blob hash is stored with the blob metadata. Any intermediate hashes and temporary blob metadata can be cleaned up at this point. In some cases, cleaning up can mean deleting some or all of the intermediate hashes and/or temporary blob metadata.

These steps (i.e. steps 412-434) can be repeated for each blob the USVDH client wants to upload. Once all blobs are uploaded, the USVDH client can create a referencing element that references the blobs. The referencing element can describe some or all of the blobs, or it can simply contain the references to the blobs. The USVDH client can make a request to the USVDH server to commit the referencing element. In this example the request is indicated as communicate referencing element at 436.

The referencing element can subsequently be retrieved and both the referencing element and any retrieved units of the blobs can be read. In the request the USVDH client 402 makes a request that uniquely references individual blobs or blob units. For instance, the USVDH client can use a token from the blob upload parameters to identify individual blobs. In another instance, the blob ID is contained in the referencing element, and the USVDH client first requests the referencing element to get the IDs for the blobs.

In addition to the above steps, the USVDH client 402 has the option to apply a digital signature to the referencing element to ensure any readers of the data can guarantee its integrity and its source. This can be accomplished using standard digital signature techniques. If the referencing element is to be signed, the client includes the blob hashes for all the blobs that are referenced by the referencing element in the data to be signed. Since the client received the blob hash algorithm, block size and any other relevant parameters for calculating the blob hash as part of the blob upload parameters, the USVDH client is able to calculate the blob hash in a similar manner as that described above for the USVDH server 404.

In some implementations, when the USVDH client communicates the referencing element to the USVDH server at 436, the server will ensure all the blobs referenced in the referencing element have at least one chunk of data, either full or partial, that is defined for a contiguous range, and that have been marked completed as described above. If the referencing element has a digital signature applied, the USVDH server will ensure all the blobs that are referenced in the referencing element are included in the data that is signed. In another configuration, the USVDH server can also validate the digital signature of the referencing element using standard techniques. The USVDH server can ensure the blob hashes that are in the data that is signed are equal to the blob hashes that were calculated by USVDH server. This configuration can prevent a bad digital signature in the system.

The USVDH server 404 can store the referencing element including the references to the blobs. In the illustrated configuration, the USVDH server can store the referencing element in the data table 408. (Note, that data table 408 can include different and/or additional information than is illustrated). In another implementation, the USVDH server can persist a new reference to the blobs as opposed to the one that was used to identify the blob for the request to commit the referencing element. This aspect can be accomplished via data table 408 or with another data table (not shown for sake of brevity).

In some cases, the USVDH client 402 can communicate multiple referencing elements at 436. In this case, the semantics described above can be repeated for each referencing element. It is worth noting that data table 408 may be updated and/or deleted at this point. For instance, some information in the data table may no longer be needed, other information can be added, or a new data table can be created that includes information that is useful for a ‘get’ described below. For instance, blob ID, blob hash, block size, chunk size, etc. may be useful in the ‘get’ processes described below.

The above discussion relative to steps 412-436 relate to protocols, methods and systems for uploading or putting information into storage. The following discussion relates to the interactions for reading referencing elements and verifying their integrity and source. The reading USVDH client may be different from the USVDH client that uploaded the data. Specifically, the concept of unitizing the referenced data, such as into blocks, can reduce resource usage, such as bandwidth and memory that the USVDH server can use for other tasks. Some implementations can create a blob hash without needing the whole blob in memory. For instance, using block hashes can allow the block hashes to be read instead of the whole blob of data for validating the digital signature and blob hashes. Further, block hashes can be utilized to verify portions of blobs rather than having to verify the entire blob. Further still, blob hashes can be verified by the USVDH server 404 and/or USVDH client 402 without the need to have the whole blob data in memory.

At 440, negotiation can occur between the USVDH client 402 and the USVDH server 404. The negotiation can be similar to that described above relative to a ‘put.’ For instance, USVDH server 404 can interrogate the USVDH client 402 to ensure that the client has permission to access the information. The negotiation can also involve establishing a channel, etc. as discussed above. The USVDH client 402 can communicate a request to the USVDH server 404 to retrieve the referencing element at 442. In another implementation the USVDH client can fetch the referencing element which contains the parameters for getting the blobs. The USVDH client can query for the referencing element against a set of known parameters such as unique IDs of the referencing element or types of the referenced data. The USVDH server can communicate the referencing element to the USVDH client at 444.

Once the USVDH client 402 has the referencing element, the client will also have references to the blobs that can be used to read each blob. The USVDH server 404 can allow the client to read sections of the blob, say for example through byte ranges. Often, the USVDH client desires to read only a section of the blob. In such a scenario, the USVDH client can communicate a request for a byte range from the USVDH server 404 at 446. The USVDH server 404 can reference data table 408 and identify individual chunks that include the desired section of bytes.

In some implementations, having the chunk size is sufficient to satisfy a byte range query. For instance if chunk size is 10, and the requested range is 12-26, then chunk 2 can be read to get bytes 12-20 and chunk 3 read to get bytes 21-26. The USVDH server can obtain those specific chunks from storage 410 as indicated at 448. The USVDH server can decrypt the chunks. The USVDH server can then communicate the chunks to the USVDH client 402 at 450. It is noteworthy that the USVDH server does not have to communicate blocks/chunks only. For instance, since the USVDH client can request a byte range, the USVDH server can respond with data that spans multiple chunks and is not delineated by chunk boundaries. It is further noteworthy that the USVDH server does not need to obtain the entire blob from storage to accomplish this process. Further, if the desired information spans multiple chunks, individual chunks can be retrieved, validated, and forwarded to the USVDH client without waiting for all of the multiple chunks to be obtained from storage 410.

The retrieved chunks can be validated in that when an encrypted chunk is retrieved from the external store and read, decryption can be performed. Successful decryption is an indicator that the chunk has not been modified by the storage 410 (or other party). Failed decryption is an indicator that the chunk may have been modified. This decryption process can be accomplished with encryption metadata that can be stored by the USVDH server 404 in data table 408. Examples of such encryption metadata can include encryption keys and initialization vector, among others.

The above mentioned configuration can reduce resource usage, such as bandwidth and memory that the USVDH server 404 can use for other tasks. Further, this configuration can decrease the latency experienced by the USVDH client 402 in awaiting the data when compared to retrieving the entire blob.

Further, in an instance where the referencing element is signed, the signature over the referencing element can be validated by the USVDH server 404 (and/or by the requesting USVDH client) using standard digital signature validation techniques. If a certificate is available with the signature, then the USVDH client 402 may validate the certificate against a policy, for instance ‘is the signer of the data a trusted entity?’. Additionally, the individual blobs can be read from the USVDH server and the blob hashes independently calculated by the reading USVDH client. The USVDH server and/or USVDH client can compare the calculated blob hash for each blob against the hashes found in the referencing element for that blob. This gives the reading USVDH client the assurance that the blob data was not modified intentionally or unintentionally, since it was created by the original creating or ‘putting’ USVDH client.

In summary, the described implementations offer the ability to encrypt blobs on a per-chunk basis for storage in an external blob store. These implementations also offer the ability to retrieve arbitrary chunks of the blob with decryption on-the-fly. These implementations can also offer the ability to re-send a failed chunk of data while maintaining all the other functionality described herein. Networks tend to be unreliable and the likelihood of a network error while uploading large data is high, thus a solution to the problem of re-sending data in case of a failed response or timeout from the server can be advantageous.

Another described feature is the ability to upload data in an out-of-order fashion (i.e. in non-sequential byte order), and in a parallel fashion while maintaining the other functionality described herein. Parallel uploading allows improved throughput and allows USVDH techniques to adapt the performance of the data upload depending on network characteristics. For instance as network bandwidth increases over time, the USVDH techniques can utilize more parallelization in the data uploads to take advantage of the improved bandwidth.

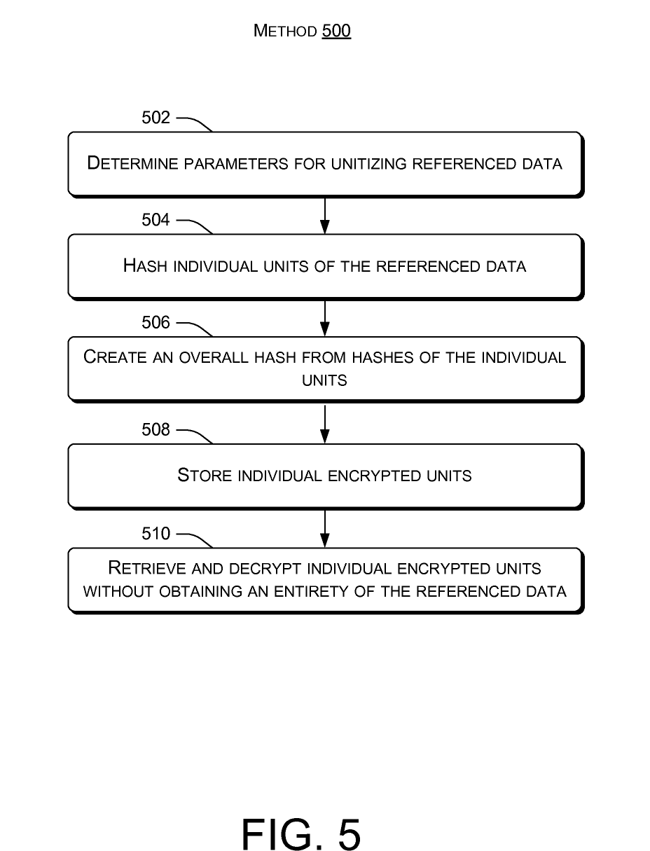

Another described feature relates to mechanisms to track the committing of data to the storage system. In cases where the nature of the storage system does not allow transacting with the storage system where the referencing elements are stored, this tracking can be utilized to ensure cleanup of data in the external store. FIG. 4 is described above in great detail. A broad USVDH method example is described below relative to FIG. 5.

### Second Method Example

FIG. 5 illustrates a flowchart of a method or technique 500 that is consistent with at least some implementations of the present concepts.

In this case, parameters are determined for unitizing referenced data at 502. Individual units of the referenced data are hashed at 504. An overall hash can be created from the hashes of the individual units at 506. Individual encrypted units can be stored at 508. The units that are encrypted may be the same or different units than the units that are hashed. Individual encrypted units can be retrieved and decrypted without obtaining an entirety of the referenced data at 510.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### System Example

FIG. 6 shows an example of a USVDH system 600. Example system 600 includes one or more USVDH client computing device(s) 602, one or more USVDH server computing device(s) 604, and storage resources 606. The USVDH client computing device 602, USVDH server computing device 604, and storage resources 606 can communicate over one or more networks 608, such as, but not limited to, the Internet.

In this case, USVDH client computing device 602 and USVDH server computing device 604 can each include a processor 610, storage 612, and a USVDH module 614. (A suffix ‘(1)’ is utilized to indicate an occurrence of these modules on USVDH client computing device 602 and a suffix ‘(2)’ is utilized to indicate an occurrence on the USVDH server computing device 604). USVDH modules 614 can be implemented as software, hardware, and/or firmware.

Processor 610 can execute data in the form of computer-readable instructions to provide a functionality. Data, such as computer-readable instructions, can be stored on storage 612. The storage can include any one or more of volatile or non-volatile memory, hard drives, and/or optical storage devices (e.g., CDs, DVDs etc.), among others. The USVDH client computing device 602 and USVDH server computing device 604 can also be configured to receive and/or generate data in the form of computer-readable instructions from an external storage 616.

Examples of external storage 616 can include optical storage devices (e.g., CDs, DVDs etc.), hard drives, and flash storage devices (e.g., memory sticks or memory cards), among others. In some cases, USVDH module 614(1) can be installed on the USVDH client computing device 602 during assembly or at least prior to delivery to the consumer. In other scenarios, USVDH module 614(1) can be installed by the consumer, such as a download available over network 608 and/or from external storage 616. Similarly, USVDH server computing device 604 can be shipped with USVDH module 614(2). Alternatively, the USVDH module 614(2) can be added subsequently from network 608 or external storage 616. The USVDH modules can be manifest as freestanding applications, application parts and/or part of the computing device's operating system.

The USVDH modules 614 can achieve the functionality described above relative to FIGS. 4-5. Further detail is offered here relative to one implementation of USVDH module 614(2) on USVDH server 604. In this case, USVDH module 614(2) includes a communication component 618, a unitization component 620, and a security component 622. Further, unitization component 620 can include a data table 624.

The communication component 618 can be configured to receive requests for a portion of a blob associated with a referencing element. The communication component is configured to verify that the received requests are from entities that have authorization to access the blobs. For instance, the communication component can ensure that the requesting entity has authority to access the referencing element. The communication component can employ various authentication schemes to avoid unauthorized disclosure.

The unitization component 620 can be configured to unitize referenced data, such as blobs, into units. The unitization component can memorialize information about individual units in data table 624. An example of a data table and associated functionality is described above relative to FIG. 4. Thus, if an authorized user identifies portions of the referenced data that the user is interested in, the unitization component can identify individual units that include the portions and cause the individual units to be obtained for the user rather than an entirety of the referenced data.

The security component 622 can be configured to validate individual units obtained by the unitization component without accessing an entirety of the referenced data. The security component can be further configured to decrypt the one or more units without decrypting the entirety of the referenced data.

In some implementations, the USVDH server 604 and its USVDH module 614(2) may be in a secure environment that also includes storage resources 606. However, such need not be the case. The functionality offered by the USVDH module 614(2) offers the flexibility that unitized referenced data can be secured in a manner such that the environment of storage resources 606 need not be secure. Such a configuration offers many more storage opportunities for the unitized data while ensuring the security and integrity of the unitized data.

It is worth noting that in some instances, the USVDH client 602 and/or the USVDH server 604 can comprise multiple computing devices or machines, such as in a distributed environment. In such a configuration, different chunks of a blob can be sent by different USVDH client machines and/or received by different USVDH server 604 machines. In at least some implementations, each chunk upload request can go to any of the USVDH server machines so load balancing can be utilized. Accordingly, no one server machine is storing the “context” for the blob in memory (e.g., the system can be referred to as “stateless”). For this reason, when a “blob complete” request is received by the USVDH server 604 any of the USVDH server machines can calculate the blob hash. This configuration is enabled, in part via the above described block hashing and storing of intermediate hashes in the data table 624.

The above configuration can allow efficient blob hash calculation for a blob. This can provide the ability to validate the integrity of the signed referencing element and the blobs it references efficiently at the time the referencing element is ‘put’. This is an effective point to perform the validation to avoid entering data with bad digital signatures. Recall that validating the integrity of the signed referencing element can be accomplished by validating its digital signature using standard techniques. Validating the integrity of the referenced blobs can be accomplished by ensuring the hashes that are part of the signed data are equal to the calculated hashes. This configuration can allow any USVDH module to accomplish this integrity validation at any point going forward.

### CONCLUSION

Although techniques, methods, devices, systems, etc., pertaining to secure and verifiable data handling are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a communication component configured to receive requests for a portion of a blob associated with a referencing element, the blob comprising one or more units;
a unitization component configured to identify individual units in which the portion is stored; and,
a security component configured to validate the individual units without accessing an entirety of the blob.

2. The system of claim 1, wherein the communication component is configured to verify that the received requests are from entities that have authorization to access the blob and the referencing element.

3. The system of claim 1, wherein the units comprises a block and wherein a chunk comprises multiple blocks, and wherein the unitization component comprises a data table that references chunks of the blob, blocks of individual chunks, byte ranges of individual blocks and hashes of individual blocks.

4. The system of claim 3, wherein the communication component, unitization component and security component are manifest in a secure environment and wherein the one or more units are stored outside of the secure environment.

5. The system of claim 1, wherein the security component is further configured to decrypt the one or more units without decrypting the entirety of the blob.

6. A method, comprising:
receiving a request to upload information, wherein the information includes a referencing element that references at least one blob;
receiving at least one chunk of an individual blob, wherein the chunk includes multiple blocks;
hashing individual blocks; and,
upon receipt of an indication that all chunks have been uploaded, creating an overall hash of the information from the block hashes rather than from the information.

7. The method of claim 6, wherein receiving at least one chunk comprises receiving multiple chunks, and wherein the multiple chunks are received in parallel.

8. The method of claim 6, wherein receiving a chunk comprises receiving multiple chunks, and wherein a first one of the multiple chunks is received from a first source and a second one of the multiple chunks is received from a second different source.

9. The method of claim 6, wherein receiving a chunk comprises receiving multiple chunks and wherein a first one of the multiple chunks is received by a first computing device comprising a server and wherein a second one of the multiple chunks is received by a second computing device of the server.

10. The method of claim 6, further comprising encrypting the at least one chunk without possessing an entirety of the blob.

11. At least one computer-readable storage medium having instructions stored thereon that, when executed by a computing device, cause the computing device to perform acts, comprising:
negotiating a channel for communicating information, wherein the information comprises a referencing element and associated referenced data that is not included in the referencing element;
dividing the referenced data into multiple chunks of a predetermined size;
dividing an individual chunk into multiple blocks of a predetermined size that is an integer factor of chunk size; and,
communicating individual blocks over the channel.

12. The computer-readable storage medium of claim 11, wherein the negotiating comprises establishing the predetermined size of the chunks and blocks.

13. The computer-readable storage medium of claim 12, wherein the establishing comprises receiving a range of size values for the blocks and chunks and selecting a value from the range as the predetermined size.

14. The computer-readable storage medium of claim 11, wherein the negotiating includes receiving a token that is utilized to uniquely identify the information.

15. The computer-readable storage medium of claim 11, wherein the negotiating includes negotiating the chunk size, the block size and a blob hash algorithm.

16. The computer-readable storage medium of claim 11, wherein the communicating comprises communicating the individual blocks in a serial or parallel fashion.

17. The computer-readable storage medium of claim 11, wherein the communicating comprises communicating the individual blocks in ascending numerical order.

18. The computer-readable storage medium of claim 11, further comprising indicating that block communication is complete.

19. The computer-readable storage medium of claim 11, wherein the referenced data comprises at least one blob and further comprising digitally signing individual blocks or digitally signing the referencing element and a hash of the at least one blob.

20. The computer-readable storage medium of claim 11, wherein the referenced data comprises at least one blob and further comprising allowing a user to sign the referencing element and a hash of the at least one blob.
